(19) United States
(12) Patent Application Publication
(10) Pub. No.: US 2002/0144610 A1
(43) Pub. Date: Oct. 10, 2002

(54) Device and process for the removal of the screen coating from printing screens for silk screen printing

(76) Inventor: Peter Zimmer, Kufstein (AT)

Correspondence Address: Lorusso & Loud, 440 Commercial Street, Boston, MA, 02109, US

(21) Appl. No.: 10/072,384

(22) Filed: Feb. 8, 2002

Related U.S. Application Data
(63) Continuation-in-part of application No. 09/597,515, filed on Jun. 20, 2000, now abandoned.

(51) Int. Cl. B41L 13/04; B41F 35/00

(52) U.S. Cl. 101/116; 101/425

(57) ABSTRACT

Device and process for the removal of the coating layer which forms the screen stencil on a rotary printing screen for screen printing from the rotary printing screen. The device comprising a rotatable support roller and a nozzle unit for spraying a jet of liquid onto the rotary printing screen at high pressure, the rotary printing screen lying on the support roller in the working area of the nozzle unit, and the device having a free space beneath the support roller for a rotary printing screen section freely suspended beneath the support roller.

The present invention relates to a device for the removal of a coating layer which forms the screen stencil on a rotary printing screen for screen printing from the rotary printing screen. The device comprises a rotatable support roller and a nozzle unit for spraying a jet of liquid onto the rotary printing screen at high pressure, the rotary printing screen lying on the support roller in the working area of the nozzle unit.

Furthermore, the present invention relates to a method for the removal of said coating layer from rotary printing screens for screen printing by means of a jet of liquid sprayed at high pressure onto a rotary printing screen lying on a support roller.

Furthermore, the present invention relates to a method for controlling the position of a rotary printing screen on a mainly horizontal rotatable support roller.

In order to be able to print a certain pattern with rotary printing screens for screen printing, it is necessary to deposit a varnish as a coating layer on the rotary printing screen which is in most cases made of nickel. The varnish initially closes all the openings of the rotary printing screen. After the subsequent curing of the varnish, certain areas of the rotary printing screen are freed of the varnish for example with a laser engraving machine so that certain openings of the rotary printing screen which correspond to a pattern become free for the passage of colour. In order to be able to repeatedly use a rotary printing screen for screen printing, it is necessary to completely remove the coating layer for varnish of the old pattern formed by the varnish before a renewed application of a screen stencil. The specialist term for this removal of a varnish deposited on the outside of the rotary printing screen for screen printing for building a screen stencil purposes is “stripping”. A difference between “stripping” and washing of a rotary printing screen has to be made as washing only removes the colour from the coating layer and keeps the coating layer itself in place on the rotary printing screen. During stripping the entire coating layer is removed from the rotary printing screen.

It is known to carrying out “stripping” with chemicals, which is ecologically problematical, as these chemicals are non-, or only poorly, degradable. It would also be conceivable to carry out “stripping” with the laser engraving machine, but this is expensive and reduces the productive working time (application of the pattern) of the laser engraving machine.

A favourable and environmentally friendly alternative is “stripping” with water, the water being sprayed at high pressure onto the rotary printing screen for screen printing. A suitable device is known for example from DE 42 24 511 A1. The device shown has a support roller, which matches as regards circumference, the rotary printing screen pushed onto it after the tension rings have been removed. The rotary printing screen thus lies on the support roller with its entire inner peripheral surface, which is disadvantageous inasmuch, as detached varnish particles get stuck between the support roller and the rotary printing screen and can only be poorly rinsed. Moreover, it is necessary to provide a support roller of suitable diameter for every rotary printing screen size.

To deal with these disadvantages, the device according to the invention provides that the device has a free space beneath the support roller for a rotary printing screen section suspended freely beneath the support roller.

The process according to the invention provides that rotary printing screens of different sizes are laid on the same support roller, a rotary printing screen section being freely suspended beneath the support roller.

Using the free space beneath the support roller, it is possible for the support roller to be relatively small, so that, even for the smallest rotary printing screen size, only a part of the screen lies on the support roller, whereas a freely suspended rotary printing screen section finds space beneath the support roller. Thus, a uniform support roller can be used for all rotary printing screen sizes. The freely suspended rotary printing screen section further prevents the detached varnish particles from getting stuck between the support roller and screen.

The freely suspended screen section further offers the advantage that a rinsing device can be provided for this. The function of the rinsing device, to remove the detached colour particles from the freely suspended screen section, can be carried out in different ways. An arrangement as a spraying device which sprays water onto the screen from inside has proved successful.

In order to ensure a full fit of the screen in the working area of the nozzle unit, a pressure roller for pressing the rotary printing screen against the support roller can be preferably provided. For adaptation to different rotary printing screen widths, it is advantageous if the width of the pressure roller can be changed by means of additional elements.

It is favourable if the support roller has areas, with slightly increased diameter, which form stops. The two stops form a lateral limitation for the rotary printing screen pushed onto the support roller, whereby a lateral “downward migration” of the rotary printing screen on the side is avoided during the course of the rotary movement of the support roller. For adaptation to different rotary printing screen widths, it is advantageous if at least one of the areas is developed to be displaceable, preferably as a displaceable sleeve.

It can further be provided to manufacture the support roller from compression-resistant and dimensionally stable material. DE 42 24 511 A1 shows a device where the support roller is formed by an inflatable supporting tube which is enclosed by a thin nickel foil. This has the effect that the support roller is deformed under the pressure of the impacting jet of liquid. On the other hand, if the support roller is formed from dimensionally stable and compression-resistant material, for example high-grade steel, then there is the advantage that the rotary screen is not only freed from the screen coating by the jet of liquid impacting at high pressure, but is also smoothed at the same time.

According to another aspect of the invention it is provided that the support roller is clamped or housed on one side. In the state of the art, the support roller has a bearing block on each side, one of these bearing blocks having to be removed in order to push the rotary screen in axial direction onto the support roller. On the other hand, the clamping of the support roller on one side makes work considerably easier. The cantilevered housing of the support roller is in addition independent of the free space beneath the support roller.

Further details and features of the present invention emerge from the following description of the figures. These show:

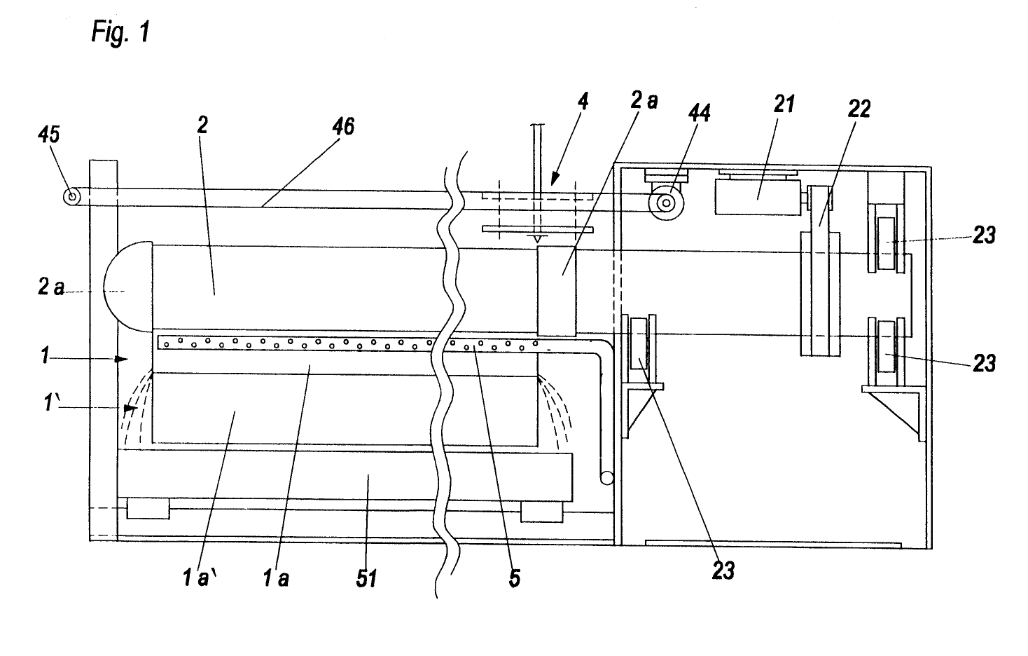

FIG. 1 a partly sectioned front view of a device according to the invention,

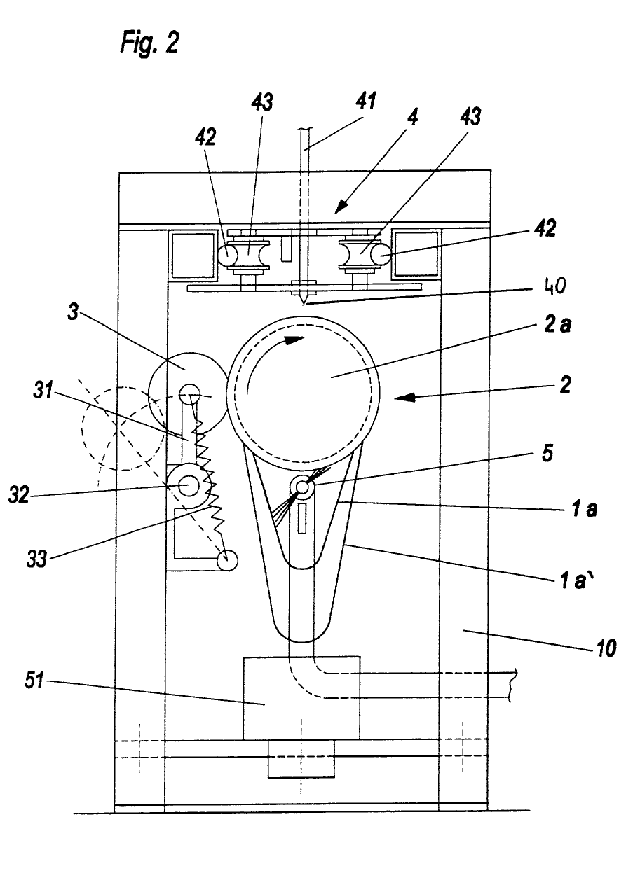

FIG. 2 an associated side view,

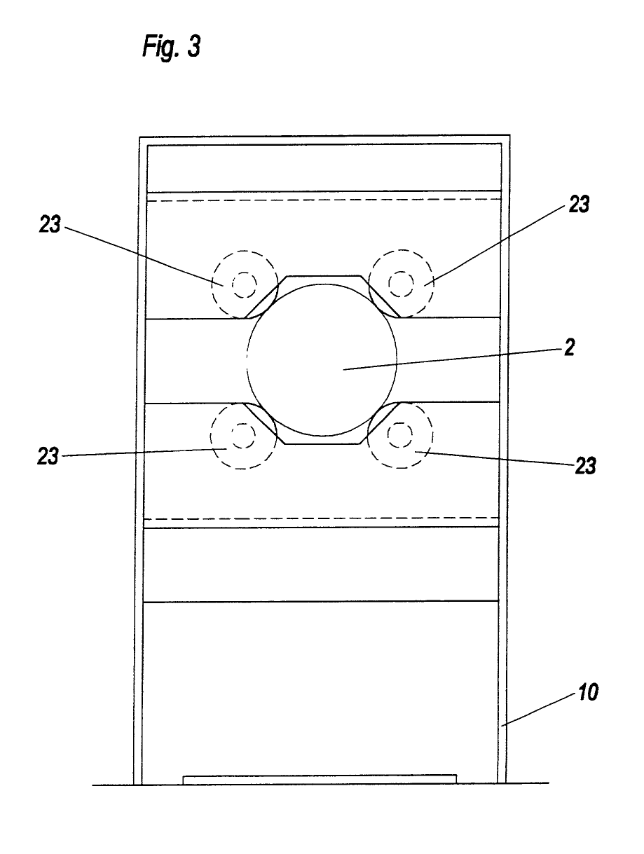

FIG. 3 a further side view from the opposite side,

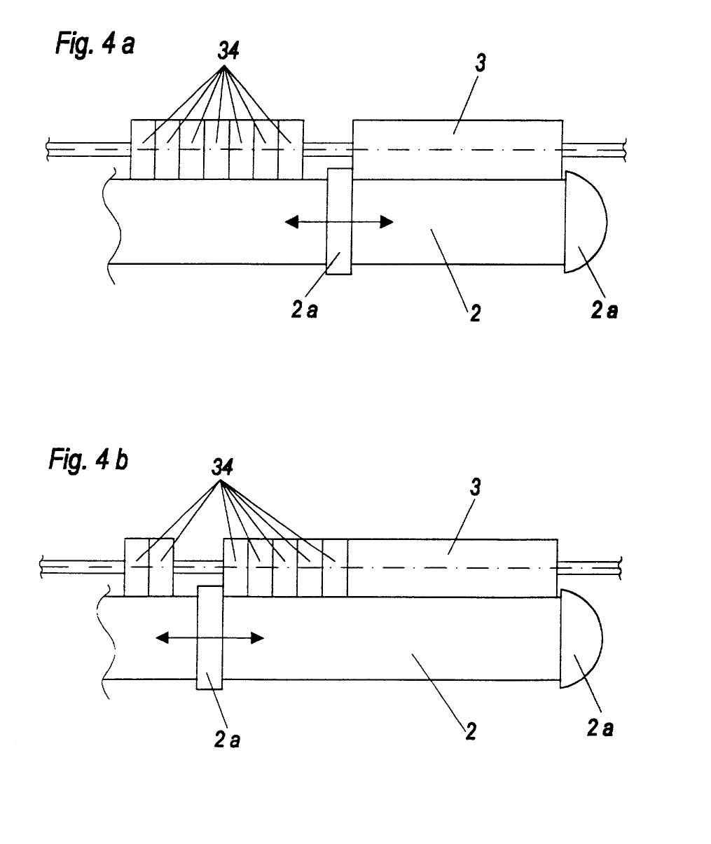

FIG. 4a and 4b a detail of an embodiment with a lateral stop,

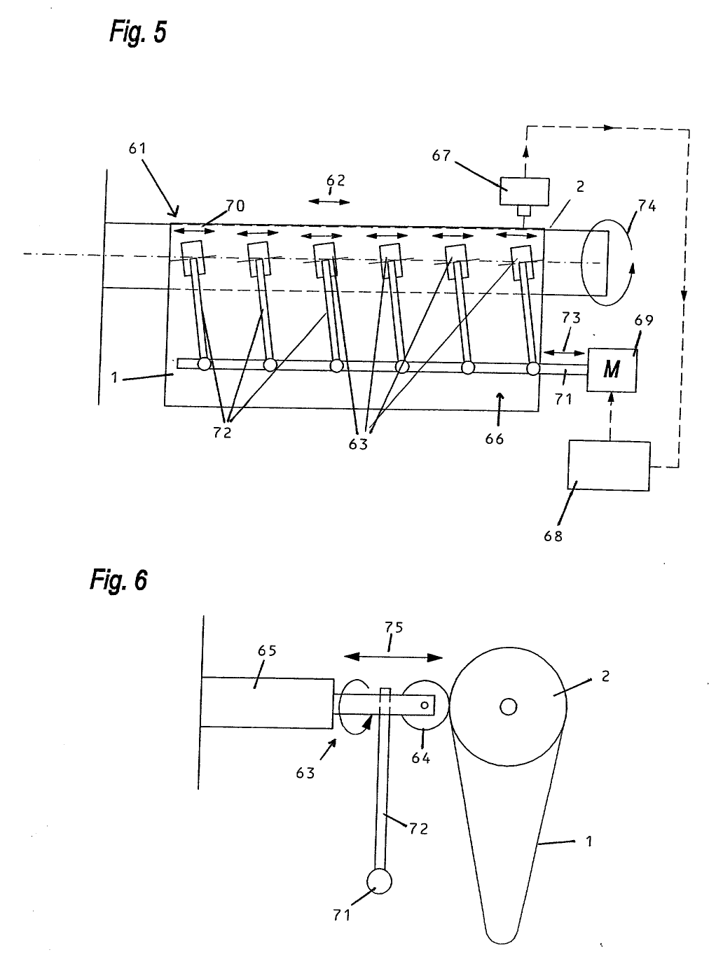

FIG. 5 a schematic front view of an embodiment with a steering device,

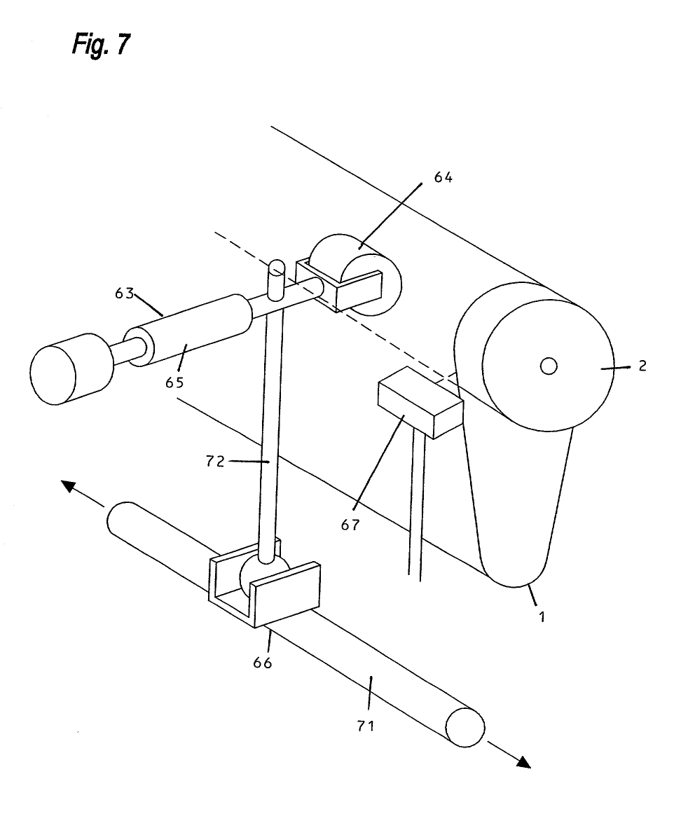

FIG. 6 a schematic side view on the embodiment shown in FIG. 5 and

FIG. 7 a further view on the embodiment shown in FIG. 5.

The central element of the device according to the invention shown in FIGS. 1 to 3 is the support roller 2. The rotary printing screens 1, 1′ to be cleaned are pushed onto this support roller 2. The support roller 2 is developed as a tube and is made from stainless high-grade steel, whereby it is compression-resistant and dimensionally stable to a high degree. These properties are essential, as the water cleaning the screens 1,1′ laid on the support roller 2 strikes the latter at very high pressure.

In order to set the support roller 2 rotating, a drive unit 21 is provided which is connected to the support roller 2 by means of a belt 22. The rotation speed of the support roller 2 can be variably adjusted and is preferably in the range of approx one revolution per second.

The support roller 2 is arranged cantilevered on the basic frame 10, i.e. it is clamped or housed on one side only. To this end, bearing rollers 23 are provided, four of which are provided at a first point and two of which at a second point. The cantilevered arrangement of the support roller 2 is essential inasmuch as the screen 1, 1′ to be cleaned can be pushed onto the support roller 2 without difficulty from the free end.

The support roller 2 has two areas 2a with slightly increased diameter. These areas form stops for the rotary printing screen 1, 1′ which has been laid on, and prevent a lateral “downward migration” during the course of the rotary movement of the support roller 2. The area 2a at the free end of the support roller 2 is developed in addition as a rounded nose, whereby the threading of the rotary printing screen 1, 1′ onto the support roller 2 is made easier.

In order to illustrate the core of the invention, two different rotary printing screens 1, 1′ are drawn in the figures, which differ in circumference and thus hang down to different extents into the free space beneath the support roller 2. The associated freely suspended rotary printing screen section is numbered 1a, 1a′. The diameter of the support roller 2 is favourably somewhat smaller than the diameter of the smallest rotary printing screen 1, 1′ to be cleaned, so that all rotary printing screen sizes can be pushed onto the support roller 2 without difficulty.

The coating layer is removed from the rotary printing screen for screen printing 1,1′ by means of the nozzle unit 4, via which water with or without additives is sprayed on at high pressure. The pressure is in the range between 1500 to 2500 bar, operation at approx 2000 bar being preferred. The stripping-liquid is supplied via a high-pressure pump, not shown, which is connected to the supply pipe 41. The high pressure of roughly 2000 bar is essential inasmuch as the rotary printing screen 1, 1′ is thereby not only cleaned but also smoothed at the same time. This happens in cooperation with the support roller 2 made from high-grade steel. After being processed on the device according to the invention, the screen 1, 1′ is thus not only freed of any coating layer, but also has no more crease marks.

In addition it should be mentioned that the circumference of the support roller is also cleaned, in order that no particles on this interrupt the full fit of the rotary printing screen against the support roller.

During spraying of the liquid, the support roller 2 is rotated on the one hand, the screen 1, 1′ being entrained by the contact pressure of the liquid. The nozzle unit 4 carries out a feed movement at the same time, for which a drive unit 44 is provided. The nozzle unit 4 is guided by means of guide rods 42 and guide rollers 43, the connection between the drive device 44 and the nozzle unit 4 being created via a toothed belt 46. This is reversed at a reversing roller 45. As an alternative to the drive shown, a feed rod drive or similar is also conceivable, however.

The feed is matched to the rotation speed of the support roller 2 as well as the width of the nozzle jet, so that a closed surface results which has been treated by the water jet. The closed surface is formed from slightly overlapping spiral strips.

The cleaning jet impacts essentially at the zenith on the support roller 2, a slight inclination relative to the vertical being possible.

In order to remove with certainty from the screen 1,1′ the varnish particles detached by the nozzle jet, a rinsing device 5 is furthermore provided. This rinsing device 5 is developed as a perforated tube through which liquid is sprayed from the inside onto the rotary printing screen 1, 1′. The liquid, preferably water, is collected in collection tank 51 and can be re-used after passing through a fine-filter unit. In this way, water consumption is kept low.

In order to position the rotary printing screen 1, 1′ securely on the support roller 2, a pressure roller 3 is provided which is shown only in FIG. 2. The pressure roller 3 extends in the area between the areas 2a with increased diameter of the support roller 2 and thus presses the rotary printing screen 1,1′ over its entire width against the support roller 2. The pressure roller 3 is held at the sides by arms 31, which can be pivoted about an axis 32. The pressure roller 3 is held in its end-positions by springs 33.

A special development of the pressure roller 3 is shown in FIGS. 4a and 4b. For optimal adaptation to the width of the rotary printing screen, a plurality of additional elements 34 can be provided which can be pushed against the pressure roller 3. In addition, the area 2a, forming a lateral stop, is developed as a displaceable sleeve.

FIGS. 5 to 7 show an alternative embodiment wherein the use of the area 2a forming a lateral stop is not necessary. The rotary printing screen is kept in position or moved laterally by a steering device 61. This steering device 61 comprises at least one, preferably several steering members 63 wherein in the case of several steering members 63 these are arranged at different spaced apart locations. Each steering member 63 comprises a contact member 64 which is preferably a roller and a pressing member 65 which is dedicated to press the contact member 64 against the rotary printing screen1 on the support roller 2. The pressing member 65 can be any suitable device which is known in the state of the art, for example a piston-cylinder arrangement which is pressurised with compressed air or hydraulic fluid.

The steering members 63 and with that the contact members 64 can be tilted in the direction of arrows 70 by a tilting member 66. The tilting member 66 can be realised in different ways. In the embodiment shown in FIGS. 5 to 7 the tilting member comprises an arrangement of a horizontal rod 71 and vertical rods 72 which are each connected on one side to the horizontal rod 71 and on the other side to one steering member 63. When the horizontal rod 71 is laterally moved by the motor 69 in direction of arrow 73 this movement is transmitted to the steering members 63 and results in a change of the tilt of the contact members 64. When rotating the support roller 2 for example in the direction of arrow 74 the rotary printing screen 1 is kept in a first or moved to a second lateral position in one of the directions 62 depending on the tilt of the contact members 64, whereby the lateral position of the rotary printing screen 1 can be adjusted. Motor 69 preferably is an electric step motor or an electric servo motor.

A sensor 67, for example a light beam sensor or other suitable sensors known in the state of the art, can be used to detect the lateral position of the rotary printing screen 1 on the support roller 2. When connecting the sensor 67 and the motor 69 to a suitable control device 68 the rotary printing screen 1 can be adjusted automatically in both directions 62.

Each contact member 64 can separately be moved in the directions of arrow 75 between a first position in which the contact member is pressed against the rotary printing screen 1 and at least a second position in which the contact member has no contact to the rotary printing screen. This makes it possible to exchange the rotary printing screens easily and makes it possible to adapt the number of steering members 63 in use to the lateral width of the rotary printing screen 1 from which the coating layer has to be removed.

1. A device for removing a coating layer which forms the screen stencil on a rotary printing screen for screen printing from said rotary printing screen comprising:
a frame;
a mainly horizontal rotatable support roller, wherein said support roller is attached to said frame such that a free space is created beneath said support roller, wherein said rotary printing screen is exchangeable arrangeable on said rotatable support roller such that a section of said rotary printing screen is directly supported by said support roller whereas another section of said rotary printing screen is freely suspended in said free space beneath said support roller; and
at least one nozzle unit, wherein said nozzle unit is positioned so that a high pressure jet of liquid expelled from said nozzle is substantially directed towards said rotary printing screen, wherein said high pressure jet removes said coating layer.

2. The device according to claim 1, further comprising a rinsing device for transporting removed coating layer pieces from said rotary printing screen.

3. The device according to claim 2, wherein said rinsing device is arrangeable inside said freely suspended portion of said rotary printing screen beneath said support roller.

4. The device according to claim 1, wherein said nozzle unit is arranged so that the jet of liquid expelled from said nozzle is directed downward in a substantially vertical direction towards a section of said rotary printing screen, said section being directly supported by the surface of said support roller.

5. The device according to claim 1, further comprising a pressure roller to press the rotary printing screen against said support roller.

6. The device according to claim 1, wherein said support roller has at least one area having a slightly increased diameter, said area forming a lateral stop for the rotary printing screen.

7. The device according to claim 6, wherein said at least one area is displaceable.

8. The device according to claim 1, wherein said support roller is made from a compression-resistant and dimensionally stable material.

9. The device according to claim 8, wherein said support roller is made of metal.

10. The device according to claim 9, wherein said support roller is made of high-grade steel.

11. The device according to claim 1, wherein said support roller is cantilevered to said frame.

12. The device according to claim 1, further comprising a drive device for carrying out a movement of said at least one nozzle unit along said support roller.

13. The device according to claim 12, wherein the movement of said drive device is matched to the rotation speed of said support roller as well as to the width of said high pressure jet of liquid expelled from said nozzle unit so that said coating layer is completely removed from said rotary printing screen.

14. The device according to claim 1, further comprising a steering device for controlling the position of said rotary printing screen on said support roller in the horizontal direction, wherein said steering device comprises at least one steering member with a contact member and a pressing member wherein said contact member slides or rolls on said rotary printing screen and is pressable against said rotary printing screen on said support roller by said pressing member.

15. The device according to claim 14, wherein said contact member is a roller.

16. The device according to claim 14, wherein said steering device comprises a tilting member for tilting at least one steering member.

17. The device according to claim 16, wherein said tilting member is arranged for tilting all steering members.

18. The device according to claim 16, wherein said steering device comprises an electric servo motor for driving said tilting member.

19. The device according to claim 14, wherein at least one steering member is moveable between a first position in which said contact member is pressed against said rotary printing screen on said support roller and a second position in which said contact member is not in contact with said rotary printing screen on said support roller.

20. The device according to claim 14, wherein said steering device comprises a sensor for detecting the lateral position of said rotary printing screen on said support roller in the horizontal direction.

21. The device according to claim 14, wherein said steering device comprises several steering members, the contact members of which are pressable against the rotary printing screen at different spaced apart locations.

22. A method for the removal of a coating layer which forms the screen stencil on a rotary printing screen for screen printing from said rotary printing screen comprising the steps of:
Placing said rotary printing screen onto a support roller such that a section of said rotary printing screen is directly supported by said support roller whereas another section of said rotary printing screen is freely suspended beneath said support roller, said support roller being able to accommodate rotary printing screens of varying circumferences; and spraying a high pressure jet of liquid onto the screen to remove the coating layer.

23. A method for controlling the position of a rotary printing screen on a mainly horizontal rotatable support roller comprising the steps of:
pressing a contact member of at least one steering member of a steering device against said rotary printing screen on said rotatable support roller,
detecting the position of said rotary printing screen on said support roller in the horizontal direction with a sensor and
tilting said contact member on said rotary printing screen while said support roller moves said rotary printing screen by rotating thereby adjusting the lateral position of the rotary printing screen on the support roller.
